(19) United States
(12) Patent Application Publication
(10) Pub. No.: US 2024/0016172 A1
(43) Pub. Date: Jan. 18, 2024

(54) CANNABINOID INFUSED COFFEE AND METHODS OF MAKING SAME

(71) Applicant: Bidio, LLC, Boca Raton, FL (US)

(72) Inventor: Steven Greenfield, Boca Raton, FL (US)

(21) Appl. No.: 18/240,578

(22) Filed: Aug. 31, 2023

Related U.S. Application Data
(63) Continuation of application No. PCT/US2022/018103, filed on Feb. 28, 2022.
(60) Provisional application No. 63/200,323, filed on Mar. 1, 2021.

(51) Int. Cl. A23F 5/14; A23F 5/08; B65D 85/804; A23F 5/26

(52) U.S. Cl. CPC A23F 5/14; A23F 5/08; B65D 85/8043; A23F 5/26

(57) ABSTRACT

Provided herein are methods of making cannabinoid, including cannabidiol, infused beverages, including coffee.

### RELATED APPLICATIONS

This application is a continuation under 35 USC § 120 of International Patent Application No. PCT/US2022/018103, filed Feb. 28, 2022, which claims priority to U.S. Provisional Patent Application No. 63/200,323, filed Mar. 1, 2021. The contents of the above-referenced applications are incorporated by reference herein in their entirety.

### FIELD

Provided herein are cannabinoid infused coffee compositions and methods of making such compositions.

### BACKGROUND

Cannabinoids are a group of closely related compounds, including tetrahydrocannabinol and cannabidiol, isolated from cannabis. Cannabinoids have been the subject of extensive research related to their pharmacological properties, including use as nutraceuticals and supplements. Recently, cannabinoid infused beverages have been marketed, including cannabinoid infused coffee and tea. However, analysis of such products indicates that very little, if any, of the cannabinoid is present in the brewed beverage (see, e.g., U.S. Pat. No. 10,485,373). Thus, there is a need for methods of making cannabinoid infused beverages that contain desired amounts of cannabinoids.

### SUMMARY

Provided herein are methods of making cannabinoid infused brewed beverages. In one embodiment, the beverage is chocolate, coffee or tea. In another embodiment, the coffee is cappuccino, latte or espresso.

In one embodiment, the methods are for making cannabinoid infused coffee. In such embodiments, the methods involve mixing nanoparticle cannabinoid powder with ground coffee under conditions and in an amount such that the resulting cannabinoid coffee mixture, when brewed, results in brewed coffee containing a desired amount of cannabinoid.

Further provided herein is brewed cannabinoid infused coffee prepared by brewing a cannabinoid coffee mixture provided herein.

### DETAILED DESCRIPTION

### I. Definitions

To facilitate understanding of the disclosure set forth herein, a number of terms are defined below.

Unless defined otherwise, all technical and scientific terms used herein have the same meaning as is commonly understood by one of ordinary skill in the art. All patents, applications, published applications and other publications are incorporated by reference in their entirety. In the event that there are a plurality of definitions for a term herein, those in this section prevail unless stated otherwise.

The singular forms “a,” “an,” and “the” include plural references, unless the context clearly dictates otherwise.

As used herein, “brewed coffee” refers to coffee that is ready for consumption.

As used herein, “broad spectrum CBD” refers to a mixture of cannabinoids, including a range of naturally occurring compounds from the cannabis plant, but no tetrahydrocannabinol (THC). Broad-spectrum CBD products contain various compounds and cannabinoids from the cannabis plant, such as cannabichromene (CBC), cannabinol (CBN), and terpenes, such as myrcene, limonene, or pinene. Broad spectrum CBD may be extracted from cannabis plant using standard techniques well known in the art, including steam distillation, solvent extraction, carbon dioxide extraction or lipid extraction. The strain of cannabis plant, its classification, and the extraction process may affect broad spectrum CBD's composition. See, e.g., www.medicalnewstoday.com/articles/broad-spectrum-cbd.

As used herein, “cannabinoid coffee mixture” refers to a dry mixture of an encapsulated cannibinoid and ground coffee.

As used herein, “CBD” refers to cannabidiol (i.e., 2-[(1R,6R)-3-methyl-6-prop-1-en-2-ylcyclohex-2-en-1-yl]-5-pentylbenzene-1,3-diol).

As used herein, a “K-Cup®” refers to a cartridge, generally a plastic cup, for use in machines sold by Keurig Green Mountain, Inc. The cartridge has a plastic ring covered with a foil top. The inside of the capsule is lined with a filter material and keeps the coffee contained while brewing.

As used herein, a “Nespresso® capsule” refers to a type of pre-apportioned single-use capsule or pod for use in Nespresso® machines sold by Nestle Nespresso S.A.

As used herein, “particle density” refers to the size of ground coffee particles.

### II. Methods of Making Cannabinoid Infused Coffee

In one embodiment, the methods provided herein include the steps of:
(i) grinding roasted coffee beans using an industrial grinder with a set precision grinder setting of between 700 and 880 particle density;
(ii) suspending cannabinoid oil in water allowing the cannabinoid molecules to form nanoparticles;
(iii) adding an acacia fiber blend to the cannabinoid oil in water suspension to encapsulate the cannabinoid and form a cannabinoid powder; and
(iv) mixing the cannabinoid powder from step (iii) with the ground coffee from step (i) in a low friction ribbon mixer set at a maximum of 72 rpm for 60 minutes.

In one embodiment, steps (ii) and (iii) above result in a cannabinoid powder that is both readily dispersible in liquid as well as able to survive the heat and pressure of a K-Cup® or Nespresso® capsule brewing process. In certain embodiments, the cannabinoid powder is a microencapsulated cannabinoid powder or a nanoencapsulated powder. In another embodiment, the encapsulated cannabinoid has a particle size small enough to pass through a K-Cup® filter.

In one embodiment, the cannabinoid is microencapsulated. Microencapsulation is a process in which tiny particles or droplets are surrounded by a coating to give small capsules generally less than 100 μm, less than 10 μm or less than 1 μm in size. Microencapsulation can be used to enclose liquids inside a micrometric wall made of hard or soft soluble film. In one embodiment, a microcapsule is a small sphere comprising a near-uniform wall enclosing some material, e.g., a cannibinoid. This enclosed material in the microcapsule is referred to as the core, internal phase, or fill, whereas the wall is sometimes called a shell, coating, or membrane. Some materials like lipids and polymers, such as alginate, may be used as a mixture to trap the material of interest, e.g., a cannabinoid, inside. In some embodiments, the coating materials generally used for microencapsulation coatings are ethyl cellulose, polyvinyl alcohol, gelatin and/or sodium alginate. In other embodiments, the core may be a crystal, a jagged adsorbent particle, an emulsion, a Pickering emulsion, a suspension of solids, or a suspension of smaller microcapsules. In other embodiments, microcapsules have multiple walls.

In one embodiment herein, the cannabinoid is microencapsulated according to standard methods known in the art. Non-limiting embodiments of such methods include physical methods (e.g., pan coating, centrifugal extrusion, vibrational nozzle core-shell encapsulation, spray drying), physicochemical methods (e.g., ionotropic gelation, coacervation-phase separation) and chemical methods (e.g., interfacial polycondensation, interfacial cross-linking, in situ polymerization, matrix polymerization). In one embodiment, the method is spray drying.

In another embodiment, the cannabinoid is nanoencapsulated. In one embodiment, the size of the nanocapsule used herein is less than 1000 nm, less than 100 nm or less than 10 nm. As is known to those of skill in the art, a nanocapsule structure consists of a nanovesicular system that is formed in a core-shell arrangement. The shell of a typical nanocapsule is made of a polymeric, e.g., biodegradable polyester, membrane or coating. Poly-e-caprolactone (PCL), poly(lactide) (PLA), and poly(lactide-co-glicolide) (PLGA) are typical polymers used in nanocapsule formation. Other polymers include thiolated poly(methacrylic acid) and poly(N-vinylpyrrolidone). In other embodiment, naturally occurring polymers such as chitosan, gelatin, sodium alginate, and albumin are used in preparing nanocapsules. In another embodiment, the polymer is a lipid, collagen, gelatin or albumin. In other embodiments, nanocapsule shells include liposomes, along with polysaccharides and saccharides. In one embodiment, the core of a nanocapsule is composed of an oil surfactant that is specifically selected to coordinate with the selected compound, e.g., a cannabinoid, within the polymeric membrane. The specific oil used must be highly soluble with the compound, and non-toxic when used in a biological environment. The oil-compound emulsion must have low solubility with the polymer membrane to ensure that the compound will be carried throughout the system properly and be released at the proper time and location. When the proper emulsion is obtained, the compound should be uniformly dispersed throughout the entire internal cavity of the polymeric membrane. In certain embodiments, nanocapsules are prepared according to methods well known to those of skill in the art. In one embodiment, nanocapsules may be prepared by nanoprecipitation, emulsion-diffusion, double emulsification or emulsification coacervation.

In some embodiments, the cannabinoid for use in the methods provided herein is THC (tetrahydrocannabinol, including delta-9- and delta-8-tetrahydrocannabinol), THCA (tetrahydrocannabinolic acid). CBD (cannabidiol), CBDA (cannabidiolic acid), CBN (cannabinol), CBG (cannabigerol), CBC (cannabichromene), CBL (cannabicyclol), CBV (cannabivarin), THCC (tetrahydrocannabiorcol), THCV (tetrahydrocannabivarin), THCP (tetrahydrocannabiphorol), CBDV (cannabidivarin), CBCV (cannabichromevarin), CBGV (cannabigerovarin), CBGM (cannabigerol monomethyl ether), CBE (cannabielsoin), CBT (cannabicitran) and mixtures thereof. In certain embodiments, the cannabinoid is not THC. In certain embodiments, the cannabinoid is not delta-9-tetrahydrocannabinol or delta-8-tetrahydrocannabinol. In certain embodiments, the cannabinoid is not delta-9-tetrahydrocannabinol. In another embodiment, the cannabinoid is cannabidiol (herein “CBD”). In another embodiment, the cannabinoid oil for use herein contains at least one cannabinoid.

In another embodiment, the methods provided herein further include the step of:
(v) packing the mixture from step (iv) in either K-Cups® or Nespresso® capsules.

In another embodiment, provided herein is a K-Cup® or Nespresso® capsule prepared by the methods provided herein.

In another embodiment, the methods provided herein further include the step of:
(vi) brewing CBD infused coffee with the K-Cup® or Nespresso® compatible capsule of step (v).

In another embodiment, provided herein is brewed cannabinoid infused coffee prepared by the methods provided herein.

In one embodiment, provided herein is a method of making brewed CBD infused coffee including the steps of:
(i) grinding roasted coffee beans using an industrial grinder with a set precision grinder setting of between 700 and 880 particle density;
(ii) suspending broad-spectrum CBD oil in water allowing the CBD molecules to form nanoparticles;
(iii) adding an acacia fiber blend to the CBD oil in water suspension to encapsulate the CBD, resulting in a CBD powder that is both readily dispersible in liquid as well as able to survive the heat and pressure of a K-Cup® or Nespresso® capsule brewing process;
(iv) mixing the CBD powder from step (iii) with the ground coffee from step (i) in a low friction ribbon mixer set at a maximum of 72 rpm for 60 minutes;
(v) packing the mixture from step (iv) in either K-Cups® or Nespresso® capsules; and
(vi) brewing CBD infused coffee with the K-Cup® or Nespresso® compatible capsule of step (v).

In one embodiment, step (iii) of the method is spray drying.

In one embodiment, the methods provided herein result in brewed coffee having a single dosage of 10 to 25 mg CBD. In another embodiment, the dosage of CBD in the brewed coffee prepared by the methods provided herein is 10 mg of CBD, 15 mg of CBD, 20 mg of CBD or 25 mg of CBD. In another embodiment, the dosage of CBD in the brewed coffee prepared by the methods provided herein is 10 mg of CBD. In another embodiment, the dosage of CBD in the brewed coffee prepared by the methods provided herein is 15 mg of CBD. In another embodiment, the dosage of CBD in the brewed coffee prepared by the methods provided herein is 20 mg of CBD. In another embodiment, the dosage of CBD in the brewed coffee prepared by the methods provided herein is 25 mg of CBD.

In some embodiments, it was found herein that the the amount of CBD powder that was added to the mixer in step (iv) in the methods provided herein accounted for a loss ratio of 52% (i.e., 52% of the CBD is lost during brewing). This loss ratio was determined herein to be due to inefficiencies of the K-Cup® brewing process or the Nespresso® capsule brewers. Thus, in certain embodiments, the K-Cup® or the Nespresso® capsule provided herein contains 21 to 52 mg CBD. In another embodiment, the K-Cup® or the Nespresso® capsule provided herein contains 21 mg of CBD. In another embodiment, the K-Cup® or the Nespresso® capsule provided herein contains 31 mg of CBD. In another embodiment, the K-Cup® or the Nespresso® capsule provided herein contains 42 mg of CBD. In another embodiment, the K-Cup® or the Nespresso® capsule provided herein contains 52 mg of CBD.

In certain embodiments herein, a minimum of 30 pounds of coffee is mixed with the CBD powder in the methods provided herein to achieve a uniform mixing, providing a uniform distribution of CBD throughout the ground coffee. As will be appreciated by those of skill in the art, the minimum amount of coffee used in the mixing process will depend on the size and efficiency of the mixer apparatus.

In some embodiments herein, the roasted coffee for use in the methods provided herein is prepared by:
(a) roasting green coffee beans to a desired taste: either light, medium or dark;
(b) cooling the roasted coffee for between 32 and 48 hours in a low humidity environment (below 50% humidity); and
(c) storing the roasted and cooled coffee in a humidity-controlled environment (below 50% humidity) until ground.

### III. Encapsulated Cannabinoids

In one embodiment, an encapsulated cannabinoid, e.g., CBD, for use in the methods provided herein is prepared according to steps (ii) and (iii) as described herein. In other embodiments, other methods of encapsulation known in the art are used to prepare encapsulated CBD. In one embodiment, the encapsulated cannabinoid, e.g., CBD, for use in the methods provided herein is a liposomal formulation (see, e.g., U.S. Pat. No. 10,052,303 and Bulbake, et al., Pharmaceutics, 2017, 9(2):12). In other embodiments, the encapsulated cannabinoid, e.g., CBD for use in the methods provided herein may be prepared according to methods known in the art, see, e.g., U.S. Pat. No. 10,738,268, U.S. patent application Ser. No. 16/439,706 and US Patent Application Publication Nos. 2019/0247325, 2019/0216870, 2020/0289595 and 2021/0015786.

### VIII. Examples

The examples below are meant to illustrate certain embodiments provided herein, and not to limit the scope of this disclosure.

### Example 1

Green coffee beans were roasted to the desired taste: either light, medium or dark. After the roasting process was complete, the coffee was allowed to cool for between 32 and 48 hours in a low humidity environment (below 50% humidity).

After cooling for the aforementioned 32 to 48 hours, the coffee was stored in a humidity-controlled environment (below 50% humidity) until ground.

The roasted coffee beans were ground using an industrial grinder with a set precision grinder setting of between 700 to 880 particle density setting. Grinding the roasted coffee beans at this setting ensured a flow of water through-out a K-Cup® or Nespresso® capsule that extrapolates a maximum pull-through of coffee and CBD into the brewed cup.

CBD used in this process was in the form of a water-soluble powder made with premium broad-spectrum CBD. Through an emulsion process, CBD oil was suspended in water allowing the CBD molecules to form nanoparticles. This nanoparticle CBD was then spray dried onto an acacia fiber blend. This resulted in a CBD powder that was both readily dispersible in liquid as well as able to survive the heat and pressure of the K-Cup® or Nespresso® capsule brewing process. In one example, nanoparticle CBD for use in these methods was Hydrobond CBD™ Water Soluble Powder, sold by Open Book Extracts, Roxboro, NC (see, openbookextracts.com/product/hydrobond-cbd-powder). Briefly, HydroBond CBD™ Water Soluble Powder is a water soluble CBD powder made with Open Book Extracts' premium broad spectrum CBD oil. Through an emulsion process, the oil is suspended in water allowing the CBD molecules to form nanoparticles. Once the emulsion process is complete, the nanoparticle CBD is spray-dried onto a proprietary acacia fiber blend resulting in powder that is readily dispersible in liquid with no oily surfactants or bitter taste.

Prior to mixing the CBD water soluble powder with the ground coffee, the CBD was stored in an airtight, low-humidity environment that was protected from all sunlight.

To ensure both uniform mixing of the CBD powder with the ground coffee as well as to protect the CBD powder from shear, the mixing was done in the following manner: The mixing was done in a low friction ribbon mixer, that was set at a maximum of 72 rpm. The CBD powder and coffee was mixed at this rpm speed for a minimum of 60 minutes.

In order to ensure a precision dosage of either 10 mg of CBD, 15 mg of CBD, 20 mg of CBD or 25 mg of CBD was delivered to the brewed cup, the amount of CBD powder that was added to the mixer accounted for a loss ratio of 52%. This loss ratio was due to the inefficiencies of the K-Cup® brewing process or the Nespresso® compatible capsule brewers. Thus, in one example, in order to have a 10 mg dose of CBD delivered to a brewed cup of coffee through a K-Cup® or Nespresso® capsule process, the K-Cup® or Nespresso® capsule was packed with 21 mg of CBD.

A minimum of 30 pounds of coffee was mixed with the CBD powder to achieve a uniform mixing, providing a uniform distribution of the CBD throughout the ground coffee.

For K-Cups®: The mixture was then packed in Recyclable Number #5 K-Cups®. Each K-Cup® contained between 10-13 grams of coffee as well as the desired amount of CBD.

For Nespresso® compatible capsules: The mixture was then packed in Nespresso® compatible capsules. Each capsule contained between 5 to 5.5 grams ground coffee.

### Example 2

A K-Cup® prepared as described in Example 1 was used to brew coffee, which was then tested for the presence of CBD. In the experiment, a K-Cup® containing dark roast coffee and 21 mg of CBD was brewed under standard conditions to provide 243.99 g of brewed coffee. Analysis of the coffee by UHPLC-DAD under standard conditions showed that it contained 10.09 mg/unit of CBD (1 unit=243.99 g brewed coffee).

This disclosure is not to be limited in scope by the embodiments disclosed in the examples which are intended as single illustrations of individual aspects, and any equivalents are within the scope of this disclosure. Various modifications in addition to those shown and described herein will become apparent to those skilled in the art from the foregoing description. Such modifications are intended to fall within the scope of the appended claims.

Various references such as patents, patent applications, and publications are cited herein, the disclosures of which are hereby incorporated by reference herein in their entireties.

What is claimed is:

1. A method of making a cannabinoid coffee mixture, comprising:
(i) grinding roasted coffee beans using an industrial grinder with a set precision grinder setting of between 700 and 880 particle density;
(ii) suspending cannabinoid oil in water allowing the cannabinoid molecules to form nanoparticles;
(iii) adding an acacia fiber blend to the cannabinoid oil in water suspension to encapsulate the cannabinoid; and
(iv) mixing the cannabinoid powder from step (iii) with the ground coffee from step (i) in a low friction ribbon mixer set at a maximum of 72 rpm for 60 minutes.

2. A cannabinoid coffee mixture prepared by the method of claim 1.

3. A method of making a cannabinoid containing K-Cup® or Nespresso® capsule, comprising:
(i) grinding roasted coffee beans using an industrial grinder with a set precision grinder setting of between 700 and 880 particle density;
(ii) suspending cannabinoid oil in water allowing the cannabinoid molecules to form nanoparticles;
(iii) adding an acacia fiber blend to the cannabinoid oil in water suspension to encapsulate the cannabinoid; and
(iv) mixing the cannabinoid powder from step (iii) with the ground coffee from step (i) in a low friction ribbon mixer set at a maximum of 72 rpm for 60 minutes; and
(v) packing the mixture from step (iv) in either K-Cups® or Nespresso® capsules.

4. A K-Cup® or Nespresso® capsule prepared by the method of claim 3.

5. A method of making a cannibinoid infused brewed coffee, comprising:
(i) grinding roasted coffee beans using an industrial grinder with a set precision grinder setting of between 700 and 880 particle density;
(ii) suspending cannabinoid oil in water allowing the cannabinoid molecules to form nanoparticles;
(iii) adding an acacia fiber blend to the cannabinoid oil in water suspension to encapsulate the cannabinoid; and
(iv) mixing the cannabinoid powder from step (iii) with the ground coffee from step (i) in a low friction ribbon mixer set at a maximum of 72 rpm for 60 minutes; and
(v) packing the mixture from step (iv) in either K-Cups® or Nespresso® capsules; and
(vi) brewing cannabinoid infused coffee with the K-Cup® or Nespresso® compatible capsule of step (v).

6. A cannabinoid infused brewed coffee prepared by the method of claim 5.

7. The the K-Cup® or Nespresso® capsule of claim 4, wherein the cannabinoid is THC (tetrahydrocannabinol, including delta-9- and delta-8-tetrahydrocannabinol), THCA (tetrahydrocannabinolic acid). CBD (cannabidiol), CBDA (cannabidiolic acid), CBN (cannabinol), CBG (cannabigerol), CBC (cannabichromene), CBL (cannabicyclol), CBV (cannabivarin), THCC (tetrahydrocannabiorcol), THCV (tetrahydrocannabivarin), THCP (tetrahydrocannabiphorol), CBDV (cannabidivarin), CBCV (cannabichromevarin), CBGV (cannabigerovarin), CBGM (cannabigerol monomethyl ether), CBE (cannabielsoin), CBT (cannabicitran) and mixtures thereof.

8. The the K-Cup® or Nespresso® capsule of claim 4, wherein the cannabinoid is not THC.

9. The the K-Cup® or Nespresso® capsule of claim 4, wherein the cannabinoid is not delta-9-tetrahydrocannabinol.

10. The the K-Cup® or Nespresso® capsule of claim 4, wherein the cannabinoid is CBD.

11. A method of preparing CBD infused brewed coffee, comprising the steps of:
(i) grinding roasted coffee beans using an industrial grinder with a set precision grinder setting of between 700 and 880 particle density;
(ii) suspending broad-spectrum CBD oil in water allowing the CBD molecules to form nanoparticles;
(iii) adding an acacia fiber blend to the CBD oil in water suspension to encapsulate the CBD, resulting in a CBD powder that is both readily dispersible in liquid as well as able to survive the heat and pressure of a K-Cup® or Nespresso® capsule brewing process;
(iv) mixing the CBD powder from step (iii) with the ground coffee from step (i) in a low friction ribbon mixer set at a maximum of 72 rpm for 60 minutes;
(v) packing the mixture from step (iv) in either K-Cups® or Nespresso® capsules; and
(vi) brewing CBD infused coffee with the K-Cup® or Nespresso® capsule of step (v).

12. A CBD infused brewed coffee prepared by the method of claim 11.

13. The brewed CBD infused coffee of claim 12 having a single dosage of 10 to 25 mg CBD.

14. The brewed CBD infused coffee of claim 13 having a single dosage of 10 mg of CBD.

15. The brewed CBD infused coffee of claim 13 having a single dosage of 15 mg of CBD.

16. The brewed CBD infused coffee of claim 13 having a single dosage of 20 mg of CBD.

17. The brewed CBD infused coffee of claim 13 having a single dosage of 25 mg of CBD.
